(19) United States
(12) Patent Application Publication
(10) Pub. No.: US 2025/0062688 A1
(43) Pub. Date: Feb. 20, 2025

(54) BOOTSTRAP CIRCUIT, POWER SUPPLY DEVICE, AND VEHICLE

(71) Applicant: ROHM CO., LTD., Kyoto (JP)

(72) Inventor: Isao TAKOBE, Kyoto (JP)

(21) Appl. No.: 18/938,993

(22) Filed: Nov. 6, 2024

Related U.S. Application Data
(63) Continuation of application No. PCT/JP2023/016671, filed on Apr. 27, 2023.

(30) Foreign Application Priority Data
May 11, 2022 (JP) 2022-078098

(51) Int. Cl. H02M 3/145; B60R 16/03; H02M 3/07

(52) U.S. Cl. CPC H02M 3/145; B60R 16/03; H02M 3/07

(57) ABSTRACT

A bootstrap circuit includes a first switch configured to have a first terminal to which a constant voltage is applied, a capacitor configured to have a first terminal to which a second terminal of the first switch is connected and a second terminal to which a switching voltage is applied, and a controller configured to control the first switch based on the switching voltage and a control signal. The switching voltage is a voltage generated at a connection node between a first switching element and a second switching element. The second switching element is a switching element provided on a lower potential side with respect to the first switching element and configured to perform switching based on the control signal.

### CROSS-REFERENCE TO RELATED APPLICATIONS

This nonprovisional application is a continuation application of International Patent Application No. PCT/JP2023/016671 filed on Apr. 27, 2023, which claims priority Japanese Patent Application No. 2022-078098 filed in Japan on May 11, 2022, the entire contents of which are hereby incorporated by reference.

### BACKGROUND OF THE INVENTION

### 1. Technical Field

The disclosure herein relates to a bootstrap circuit, a power supply device, and a vehicle.

### 2. Description of Related Art

In power supply devices such as a switched capacitor converter and a half-bridge DC/DC converter, an N-channel MOS field-effect transistor low in on-resistance is often used as a switching element so that maximum efficiency is achieved.

Such an N-channel MOS field-effect transistor, when used as a high-side switching element, is driven by use of a bootstrap circuit (see, for example, Japanese Unexamined Patent Application Publication No. 2018-133916).

### BRIEF DESCRIPTION OF DRAWINGS

FIG. 1 is a diagram showing a comparative example of a half-bridge DC/DC converter.

FIG. 2 is a timing chart showing voltages and so on at various parts of a half-bridge DC/DC converter shown in FIG. 1 in a case where an output current is large.

FIG. 3 is a timing chart showing voltages and so on at the various parts of the half-bridge DC/DC converter shown in FIG. 1 in a case where the output current is small.

FIG. 4 is a diagram showing a configuration example of a level shifter.

FIG. 5 is a diagram showing an embodiment of the half-bridge DC/DC converter.

FIG. 6 is a timing chart showing voltages and so on at various parts of a half-bridge DC/DC converter shown in FIG. 5 in a case where an output current is large.

FIG. 7 is a timing chart showing voltages and so on at the various parts of the half-bridge DC/DC converter shown in FIG. 5 in a case where the output current is small.

FIG. 8 is an external appearance view of a vehicle.

FIG. 9 is a diagram showing a configuration of a Dickson switched capacitor converter.

FIG. 10 is a timing chart showing voltages and so on at various parts of the switched capacitor converter shown in FIG. 9.

FIG. 11 is a diagram showing a first example of a switched capacitor converter having a topology different from that of the Dickson switched capacitor converter.

FIG. 12 is a diagram showing a second example of the switched capacitor converter having a topology different from that of the Dickson switched capacitor converter.

FIG. 13 is a diagram showing a third example of the switched capacitor converter having a topology different from that of the Dickson switched capacitor converter.

FIG. 14 is a diagram showing a fourth example of the switched capacitor converter having a topology different from that of the Dickson switched capacitor converter.

### DESCRIPTION OF EMBODIMENT

In the present description, a MOS (Metal Oxide Semiconductor) field-effect transistor refers to a field-effect transistor having a gate structure composed of at least three layers that are a “layer of a conductor or a semiconductor having a small resistance value, such as polysilicon,” an “insulation layer,” and a “P-type, N-type, or intrinsic semiconductor layer.” That is, the gate structure of the MOS field-effect transistor is not limited to a three-layer structure composed of a metal, an oxide, and a semiconductor.

In the present description, a constant voltage refers to a voltage that is constant in an ideal state and is practically a voltage that may slightly vary depending on a temperature change or the like.

### Half-Bridge DC/DC Converter (Comparative Example)

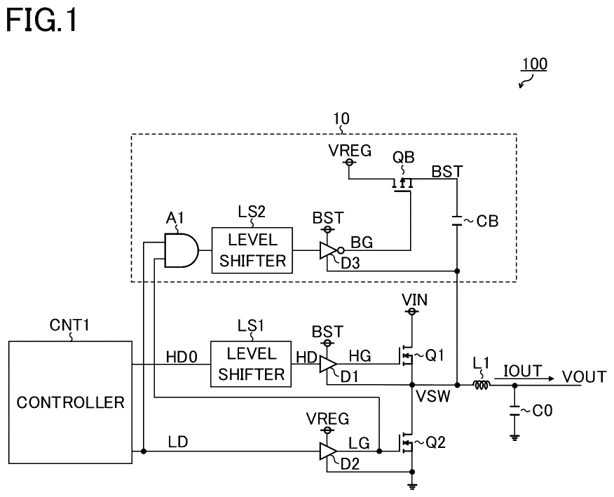

FIG. 1 is a diagram showing a comparative example (=a general configuration to be compared with an embodiment described later) of a half-bridge DC/DC converter. A half-bridge DC/DC converter 100 according to this comparative example includes a controller CNT1, a level shifter LS1, drivers D1 and D2, N-channel MOS field-effect transistors Q1 and Q2, an inductor L1, an output capacitor C0, and a bootstrap circuit 10.

The N-channel MOS field-effect transistors Q1 and Q2 are connected in series to each other. The N-channel MOS field-effect transistor Q1 acts as a high-side switch provided on a higher potential side with respect to the N-channel MOS field-effect transistor Q2. The N-channel MOS field-effect transistor Q2 acts as a low-side switch provided on a lower potential side with respect to the N-channel MOS field-effect transistor Q1.

The controller CNT1 outputs control signals HD0 and LD. Basically, when one of the control signals HD0 and LD is at a high level, the other of them is at a low level. The controller CNT1 provides a dead time in which the control signals HD0 and LD are both at the low level.

The level shifter LS1 outputs a control signal HD obtained by shifting a level of the control signal HD0. The driver D1 supplies a control signal HG obtained by amplifying the control signal HD to a gate of the N-channel MOS field-effect transistor Q1. The driver D1 is driven at a voltage between a bootstrap voltage BST and a switching voltage VSW.

The driver D2 supplies a control signal LG obtained by amplifying the control signal LD to a gate of the N-channel MOS field-effect transistor Q2. The driver D2 is driven at a voltage between a constant voltage VREG (< an input voltage VIN) and a ground voltage.

The input voltage VIN is applied to a drain of the N-channel MOS field-effect transistor Q1. A source of the N-channel MOS field-effect transistor Q2 is connected to a ground potential. As a result of switching of the N-channel MOS field-effect transistors Q1 and Q2, the switching voltage VSW is generated at a connection node between the N-channel MOS field-effect transistors Q1 and Q2.

The inductor L1 and the output capacitor C0 smooth the switching voltage VSW to generate an output voltage VOUT.

The bootstrap circuit 10 generates the bootstrap voltage BST higher than the input voltage VIN.

The bootstrap circuit 10 includes an AND gate A1, a level shifter LS2, a driver D3, a P-channel MOS field-effect transistor QB, and a capacitor CB.

The constant voltage VREG is applied to a source of the P-channel MOS field-effect transistor QB. A drain of the P-channel MOS field-effect transistor QB is connected to a first terminal of the capacitor CB. The switching voltage VSW is applied to a second terminal of the capacitor CB.

In the bootstrap circuit 10, it is required that the P-channel MOS field-effect transistor QB be kept in an off state when the switching voltage VSW is larger than 0 V. For this reason, the bootstrap circuit 10 is configured so that a logical AND between the control signal LD and the control signal LG is generated by the AND gate A1, and the P-channel MOS field-effect transistor QB is controlled based on the logical AND. Specifically, the level shifter LS2 shifts a level of an output of the AND gate A1 and then outputs the output. The driver D3 supplies a control signal BG obtained by amplifying and inverting an output of the level shifter LS2 to a gate of the P-channel MOS field-effect transistor QB. The driver D3 is driven at a voltage between the bootstrap voltage BST and the switching voltage VSW. Thus, the N-channel MOS field-effect transistor Q2 can be turned off after the P-channel MOS field-effect transistor QB has been turned off.

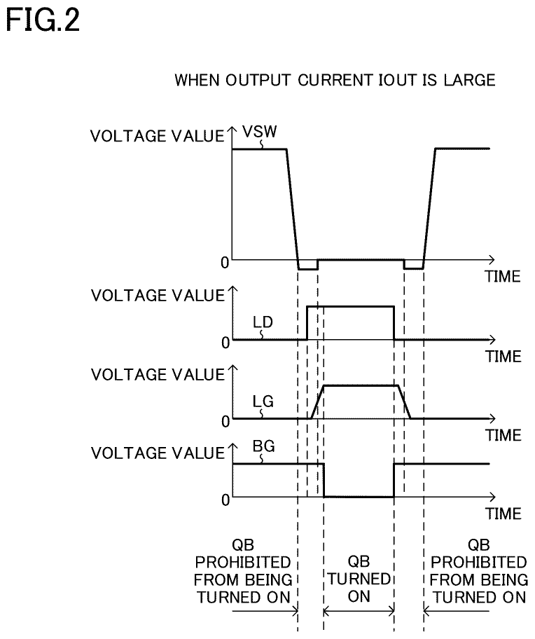

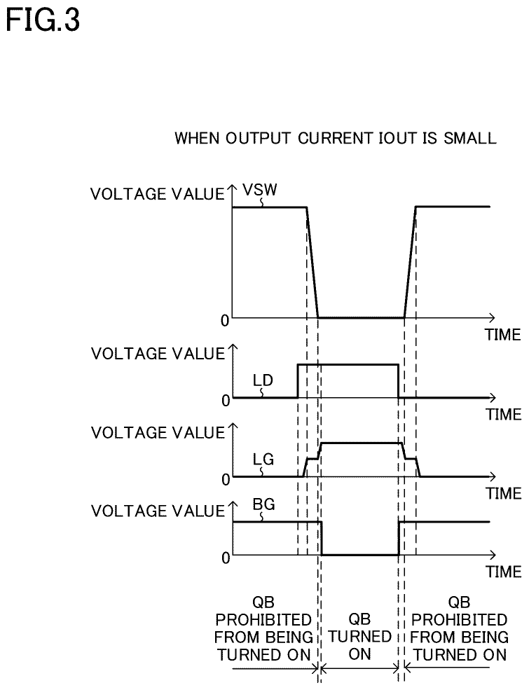

According to the bootstrap circuit 10 configured as above, even in a case where an output current IOUT of the half-bridge DC/DC converter 100 is large (see FIG. 2), and also, even in a case where the output current IOUT of the half-bridge DC/DC converter 100 is small (see FIG. 3), the P-channel MOS field-effect transistor QB can be kept in the off state when the switching voltage VSW is larger than 0 V. This configuration, however, necessitates the logical AND between the control signal LD and the control signal LG, rendering timing control complicated.

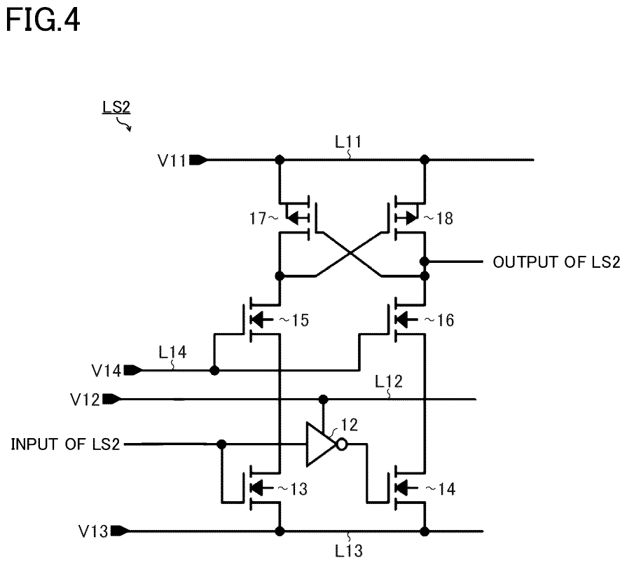

FIG. 4 is a diagram showing a configuration example of the level shifter LS2. A level shifter LS2 according to the configuration example shown in FIG. 4 includes an inverter 12, N-channel MOS field-effect transistors 13 to 16, P-channel MOS field-effect transistors 17 and 18, a first voltage line L11, a second voltage line L12, a third voltage line L13, and a fourth voltage line L14.

In the level shifter LS2 according to the configuration example shown in FIG. 4, it is required that the N-channel MOS field-effect transistors 15 and 16 be formed as elements each having a withstand voltage of a value of Vin. That is, this configuration necessitates a plurality of such elements each having a withstand voltage of the value of Vin, resulting in an increase in area of the level shifter LS2 according to the configuration example shown in FIG. 4.

In view of what has been discussed above, the following proposes a novel embodiment in which an on-resistance of a switching element driven using a bootstrap voltage can be further decreased, and timing control in a bootstrap circuit is facilitated.

### <Half-Bridge DC/DC Converter (Embodiment)>

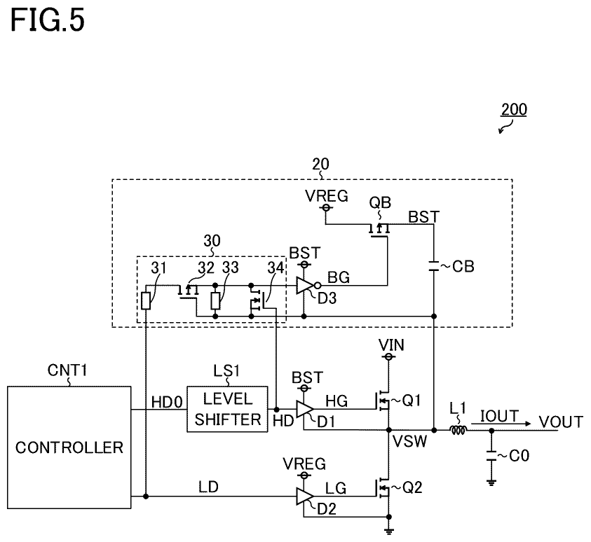

FIG. 5 is a diagram showing an embodiment of the half-bridge DC/DC converter. A half-bridge DC/DC converter 200 according to this embodiment is different from the half-bridge DC/DC converter 100 described above in that it includes a bootstrap circuit 20 instead of the bootstrap circuit 10 and is basically similar in other respects to the half-bridge DC/DC converter 100 described above.

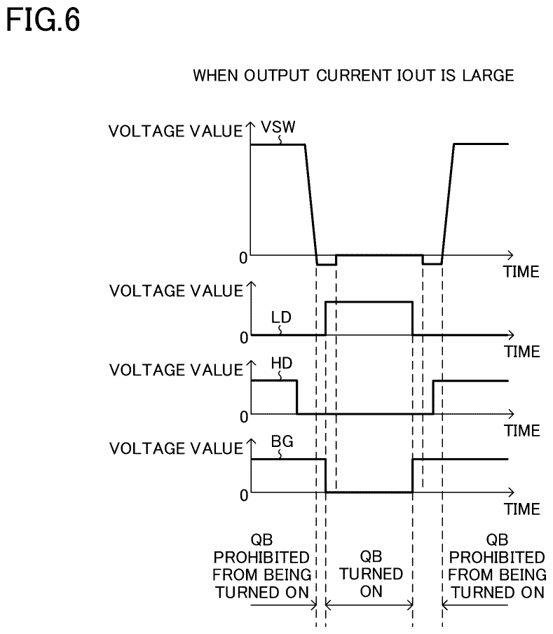

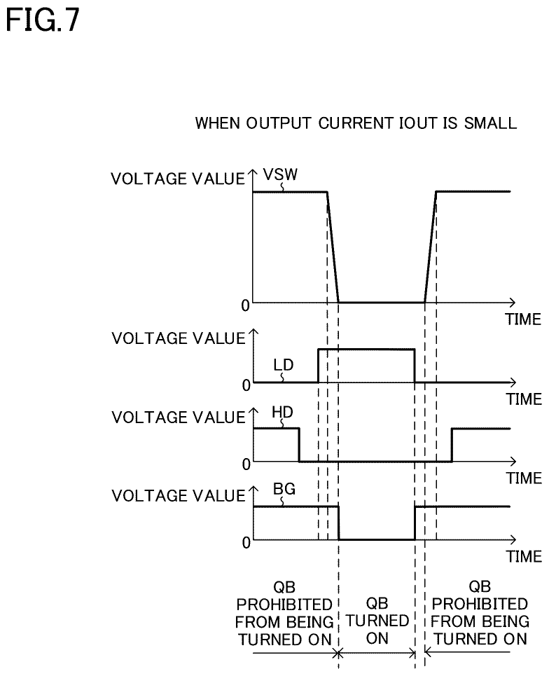

FIG. 6 is a timing chart showing voltages and so on at various parts of the half-bridge DC/DC converter 200 in a case where an output current IOUT is large. FIG. 7 is a timing chart showing voltages and so on at the various parts of the half-bridge DC/DC converter 200 in a case where the output current IOUT is small.

The bootstrap circuit 20 includes a level shifter 30, a driver D3, a P-channel MOS field-effect transistor QB, and a capacitor CB.

A constant voltage VREG is applied to a source of the P-channel MOS field-effect transistor QB. A drain of the P-channel MOS field-effect transistor QB is connected to a first terminal of the capacitor CB. A switching voltage VSW is applied to a second terminal of the capacitor CB.

A controller composed of the level shifter 30 and the driver D3 controls the P-channel MOS field-effect transistor QB based on the switching voltage VSW and a control signal LD.

The level shifter 30 includes a resistor 31, a P-channel MOS field-effect transistor 32, a resistor 33, and an N-channel MOS field-effect transistor 34.

The control signal LD is applied to a first terminal of the resistor 31. A second terminal of the resistor 31 is connected to a source of the P-channel MOS field-effect transistor 32. A drain of the P-channel MOS field-effect transistor 32 is connected to a first terminal of the resistor 33, a drain of the N-channel MOS field-effect transistor 34, and an input terminal of the driver D3. The switching voltage VSW is applied to each of a gate of the P-channel MOS field-effect transistor 32, a second terminal of the resistor 33, and a source of the N-channel MOS field-effect transistor 34.

A control signal HD is supplied to a gate of the N-channel MOS field-effect transistor 34.

The driver D3 supplies a control signal BG obtained by amplifying and inverting an output of the level shifter 30 to a gate of the P-channel MOS field-effect transistor QB. The driver D3 is driven at a voltage between a bootstrap voltage BST and the switching voltage VSW.

The bootstrap circuit 20 controls the P-channel MOS field-effect transistor QB based on the switching voltage VSW, and thus timing control is facilitated. Specifically, the bootstrap circuit 20 controls the P-channel MOS field-effect transistor QB based on a logical AND between the control signal LD and an inverted signal of the switching voltage VSW.

Furthermore, in the bootstrap circuit 20, the P-channel MOS field-effect transistor QB, which is a switch, is used instead of a diode, and thus an on-resistance of an N-channel MOS field-effect transistor Q1 driven using the bootstrap voltage BST can be further decreased.

The resistor 33 is capable of pulling down the output of the level shifter 30 when the P-channel MOS field-effect transistor 32 is in an off state. The N-channel MOS field-effect transistor 34 is controlled based on the control signal HD. The N-channel MOS field-effect transistor 34 is capable of pulling down the output of the level shifter 30 when the P-channel MOS field-effect transistor 32 is in the off state and the control signal HD is at a high level. The bootstrap circuit 20 is configured to include the N-channel MOS field-effect transistor 34, thus being capable of more reliably pulling down the output of the level shifter 30.

In a case where the N-channel MOS field-effect transistors Q1 and Q2 are Si devices, the bootstrap circuit 20 is capable of turning on the N-channel MOS field-effect transistor Q1 at appropriate timing.

In a case where the N-channel MOS field-effect transistors Q1 and Q2 are GAN devices or SiC devices, that is, in a case where, during a dead time, the switching voltage VSW has a value lower by about several volts than in the case where the N-channel MOS field-effect transistors Q1 and Q2 are Si devices, a configuration may be adopted in which, instead of the control signal LD, a control signal LG is applied to the first terminal of the resistor 31.

In the level shifter 30, the P-channel MOS field-effect transistor 32 is used as an only element having a withstand voltage of a value of Vin. Accordingly, the level shifter 30 can be reduced in area compared with the level shifter LS2 according to the configuration example shown in FIG. 4.

### Application Example

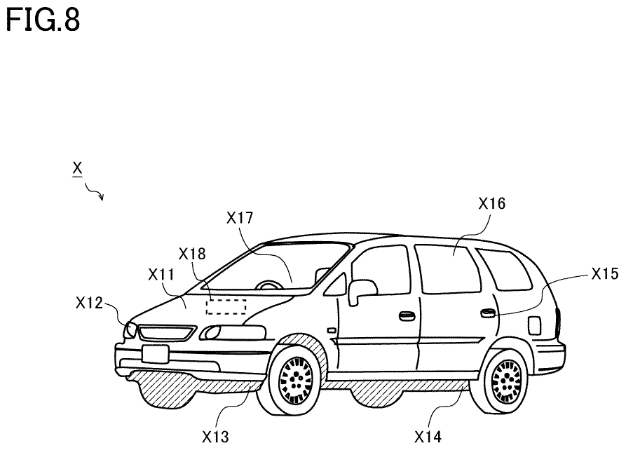

FIG. 8 is an external appearance view of a vehicle X. The vehicle X according to this configuration example mounts therein various pieces of electronic equipment X11 to X18 that operate upon receipt of supply of voltages outputted from unshown batteries. For the sake of convenience of depiction, respective mounting positions of the pieces of electronic equipment X11 to X18 shown in this drawing may be different from actual mounting positions thereof.

The electronic equipment X11 is an engine control unit that performs engine-related control (such as injection control, electronic throttle control, idling control, oxygen sensor heater control, and auto cruise control).

The electronic equipment X12 is a lamp control unit that controls turning on/off of an HID [high intensity discharged lamp], a DRL [daytime running lamp], and so on.

The electronic equipment X13 is a transmission control unit that performs transmission-related control.

The electronic equipment X14 is a brake unit that performs control related to motion of the vehicle X (such as ABS [anti-lock brake system]control, EPS [electric power steering]control, and electronic suspension control).

The electronic equipment X15 is a security control unit that performs drive control of a door lock, an anti-theft alarm, and so on.

The electronic equipment X16 includes pieces of electronic equipment incorporated in the vehicle X at a factory shipping stage as standard equipment or manufacturer optional items, such as a wiper, an electric door mirror, a power window, a damper (a shock absorber), an electric sunroof, and an electric seat.

The electronic equipment X17 includes pieces of electronic equipment optionally mounted in the vehicle X as user optional items, such as in-vehicle A/V [audio/visual]equipment, a car navigation system, and an ETC [electronic toll collection system].

The electronic equipment X18 includes pieces of electronic equipment provided with a high-withstand-voltage motor, such as an in-vehicle blower, an oil pump, a water pump, and a battery cooling fan.

The earlier described half-bridge DC/DC converter 200 can be incorporated in any of the pieces of electronic equipment X11 to X18. Furthermore, without being limited to a power supply mounted in the vehicle X, the earlier described half-bridge DC/DC converter 200 may be used also as, for example, a power supply mounted in industrial equipment.

### Others

Besides the foregoing embodiment, the configuration of the disclosure herein may be variously modified without departing from the gist of the disclosure herein. The foregoing embodiment is to be construed in all respects as illustrative and not limiting. The technical scope of the disclosure herein is indicated by the appended claims rather than by the description of the foregoing embodiment, and it is to be understood that all changes that come within the meaning and range of equivalency of the claims are intended to be embraced therein.

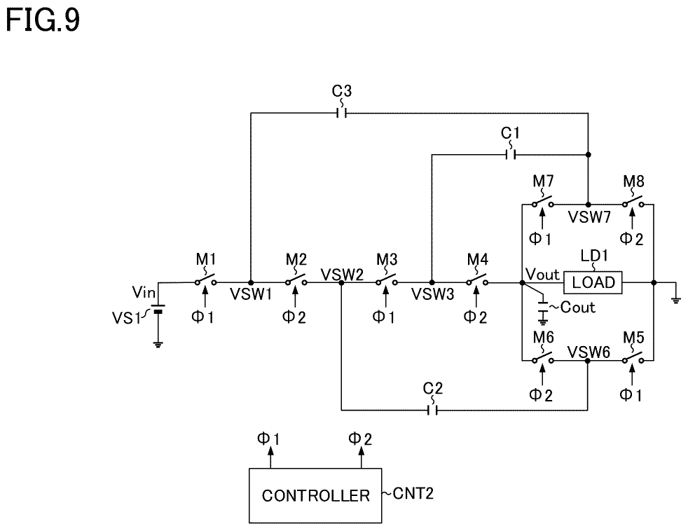

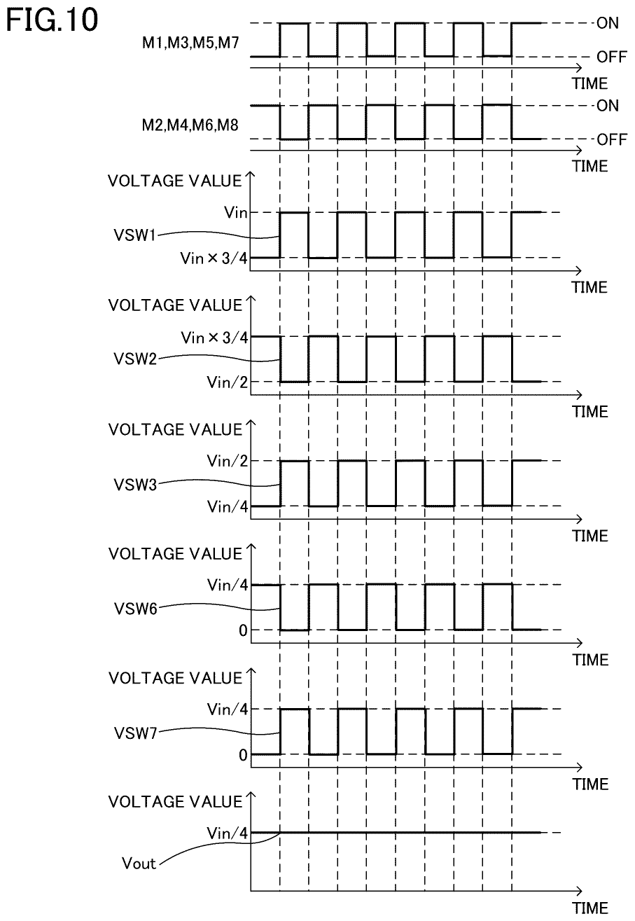

The bootstrap circuit 20 can be mounted also in a power supply device of any other type than the half-bridge DC/DC converter 200. For example, the bootstrap circuit 20 can be mounted in a Dickson switched capacitor converter shown in FIG. 9. FIG. 10 is a timing chart showing voltages and so on at various parts of the switched capacitor converter shown in FIG. 9.

The switched capacitor converter shown in FIG. 9 includes switching elements M1 to M8, capacitors C1 to C3, an output capacitor Cout, and a controller CNT2.

A first terminal of the switching element M1 is connected to a positive electrode of a direct-current voltage source VS1. A negative electrode of the direct-current voltage source VS1 is connected to a ground potential. The direct-current voltage source VS1 supplies an input voltage Vin to the first terminal of the switching element M1.

A second terminal of the switching element M1 is connected to a first terminal of the switching element M2 and a first terminal of the capacitor C3. A second terminal of the switching element M2 is connected to a first terminal of the switching element M3 and a first terminal of the capacitor C2. A second terminal of the switching element M3 is connected to a first terminal of the switching element M4 and a first terminal of the capacitor C1.

A second terminal of the switching element M4 is connected to a first terminal of the switching element M7, a first terminal of a load LD1, a first terminal of the switching element M6, and a first terminal of the output capacitor Cout. A second terminal of the switching element M7 is connected to a first terminal of the switching element M8, a second terminal of the capacitor C1, and a second terminal of the capacitor C3. A second terminal of the switching element M6 is connected to a first terminal of the switching element M5 and a second terminal of the capacitor C2. A second terminal of the switching element M8, a second terminal of the load LD1, a second terminal of the switching element M5, and a second terminal of the output capacitor Cout are connected to the ground potential.

The controller CNT2 controls the switching elements M1, M3, M5, and M7 based on a first control signal (1 and the switching elements M2, M4, M6, and M8 based on a second control signal (2.

The controller CNT2 performs control so that the switching elements M1, M3, M5, and M7 and the switching elements M2, M4, M6, and M8 are complementarily turned on/off.

A switching voltage VSW1 has a value switched between a value of Vin and a value of Vin×¾. The switching voltage VSW1 is generated at a connection node between the switching element M1 and the switching element M2.

A switching voltage VSW2 has a value switched between the value of Vin×¾ and a value of Vin/2. The switching voltage VSW2 is generated at a connection node between the switching element M2 and the switching element M3.

A switching voltage VSW3 has a value switched between the value of Vin/2 and a value of Vin/4. The switching voltage VSW3 is generated at a connection node between the switching element M3 and the switching element M4.

A switching voltage VSW6 has a value switched between the value of Vin/4 and 0 (the ground potential). The switching voltage VSW6 is generated at a connection node between the switching element M5 and the switching element M6.

A switching voltage VSW7 has a value switched between the value of Vin/4 and 0 (the ground potential). The switching voltage VSW7 is generated at a connection node between the switching element M7 and the switching element M8.

An output voltage Vout has the value of Vin/4. The output voltage Vout is generated at a connection node among the switching element M4, the switching element M6, and the switching element M7. The output voltage Vout is supplied to the load LD1.

In a case where the switching elements M1 to M8 are N-channel MOS field-effect transistors, six bootstrap circuits 20 for driving the switching elements M1 to M4, M6, and M7 could be mounted in the switched capacitor converter shown in FIG. 9.

In the switched capacitor converter shown in FIG. 9, respective locations of the direct-current voltage source VS1 and the load LD1 may be interchanged. In a case where the locations of the direct-current voltage source VS1 and the load LD1 are interchanged, a voltage supplied from the switched capacitor converter shown in FIG. 9 to the load LD1 (an output voltage of the switched capacitor converter shown in FIG. 9) becomes larger than a voltage supplied from the direct-current voltage source VS1 to the switched capacitor converter shown in FIG. 9 (an input voltage of the switched capacitor converter shown in FIG. 9).

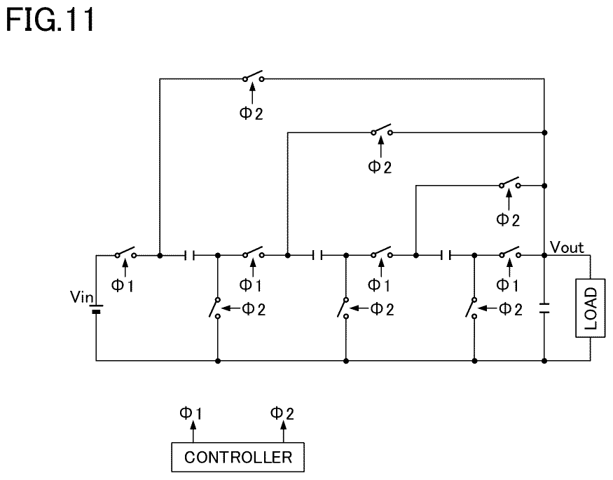

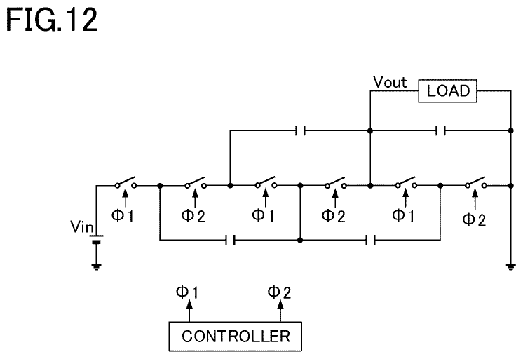

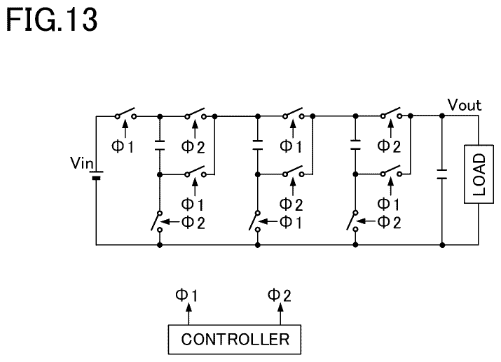

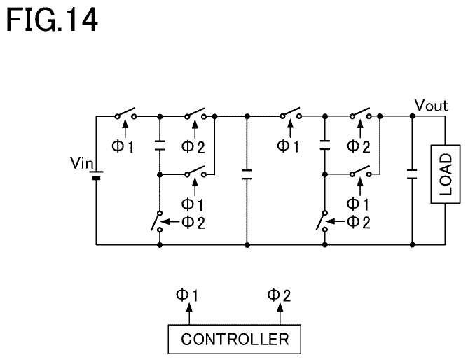

Furthermore, the bootstrap circuit 20 can be mounted also in a switched capacitor converter having a topology different from that of the Dickson switched capacitor converter. Examples of the switched capacitor converter having a topology different from that of the Dickson switched capacitor converter include switched capacitor converters shown in FIG. 11 to FIG. 14.

A bootstrap circuit (20) as described thus far has a configuration (a first configuration) including a first switch (QB) configured to have a first terminal to which a constant voltage is applied, a capacitor (CB) configured to have a first terminal to which a second terminal of the first switch is connected and a second terminal to which a switching voltage is applied, and a controller (30, D3) configured to control the first switch based on the switching voltage and a first control signal. The switching voltage is a voltage generated at a connection node between a first switching element (Q1) and a second switching element (Q2). The second switching element is a switching element provided on a lower potential side with respect to the first switching element and configured to perform switching based on the first control signal.

In the bootstrap circuit according to the above-described first configuration, an on-resistance of a switching element (the first switching element) driven using a bootstrap voltage can be further decreased, and timing control is facilitated.

The bootstrap circuit according to the above-described first configuration may have a configuration (a second configuration) in which the controller includes a level shifter (30) configured to shift a level of the first control signal.

In the bootstrap circuit according to the above-described second configuration, there can be used a level shifter reduced in circuit area.

The bootstrap circuit according to the above-described second configuration may have a configuration (a third configuration) in which the level shifter includes the P-channel MOS field-effect transistor (32), and the P-channel MOS field-effect transistor is configured to have a gate to which the switching voltage is supplied.

In the bootstrap circuit according to the above-described third configuration, the P-channel MOS field-effect transistor can be used as an only high withstand voltage element.

The bootstrap circuit according to the above-described third configuration may have a configuration (a fourth configuration) in which the P-channel MOS field-effect transistor is configured to have a drain to which the first control signal is supplied.

In the bootstrap circuit according to the above-described fourth configuration, the P-channel MOS field-effect transistor can be used as an only high withstand voltage element.

The bootstrap circuit according to the above-described third or fourth configuration may have a configuration (a fifth configuration) in which the level shifter includes a resistor (33) provided between the gate and the drain of the P-channel MOS field-effect transistor.

In the bootstrap circuit according to the above-described fifth configuration, an output of the level shifter can be pulled down when the P-channel MOS field-effect transistor is in an off state.

The bootstrap circuit according to the above-described third to fifth configurations may have a configuration (a sixth configuration) in which the first switching element is a switching element configured to perform switching based on a second control signal, the level shifter includes a second switch (34) provided between the gate and the drain of the P-channel MOS field-effect transistor, and the second switch is configured to perform switching based on the second control signal.

In the bootstrap circuit according to the above-described sixth configuration, an output of the level shifter can be pulled down when the P-channel MOS field-effect transistor is in the off state.

The bootstrap circuit according to the above-described first to sixth configurations may have a configuration (a seventh configuration) in which the first switching element and the second switching element are Si devices, and the first control signal is an input signal of a driver configured to drive the second switching element.

In the bootstrap circuit according to the above-described seventh configuration, the first switch can be turned on at timing appropriate for the first switching element and the second switching element.

The bootstrap circuit according to the above-described first to sixth configurations may have a configuration (an eighth configuration) in which the first switching element and the second switching element are GAN devices or SiC devices, and the first control signal is an output signal of a driver configured to drive the second switching element.

In the bootstrap circuit according to the above-described eighth configuration, the first switch can be turned on at timing appropriate for the first switching element and the second switching element.

The bootstrap circuit according to the above-described first to eighth configurations may have a configuration (a ninth configuration) in which the first switch is in an off state when the switching voltage has a value larger than a predetermined value.

The bootstrap circuit according to the above-described ninth configuration is capable of preventing the switching voltage from having an abnormal value.

A power supply device (200) as described thus far has a configuration (a tenth configuration) including the bootstrap circuit according to any of the above-described first to ninth configurations, the first switching element, and the second switching element.

In the power supply device according to the above-described tenth configuration, an on-resistance of the switching element (the first switching element) driven using a bootstrap voltage can be further decreased, and timing control in the bootstrap circuit is facilitated.

A vehicle (X) as described thus far has a configuration (an eleventh configuration) including the power supply device according to the above-described tenth configuration.

In the vehicle according to the above-described eleventh configuration, an on-resistance of the switching element (the first switching element) driven using a bootstrap voltage can be further decreased, and timing control in the bootstrap circuit is facilitated.

What is claimed is:

1. A bootstrap circuit, comprising:
a first switch configured to have a first terminal to which a constant voltage is applied;
a capacitor configured to have a first terminal to which a second terminal of the first switch is connected and a second terminal to which a switching voltage is applied; and
a controller configured to control the first switch based on the switching voltage and a first control signal,
wherein
the switching voltage is a voltage generated at a connection node between a first switching element and a second switching element, and
the second switching element is a switching element provided on a lower potential side with respect to the first switching element and configured to perform switching based on the first control signal.

2. The bootstrap circuit according to claim 1, wherein
the controller includes a level shifter configured to shift a level of the first control signal.

3. The bootstrap circuit according to claim 2, wherein
the level shifter includes a P-channel MOS field-effect transistor, and
the P-channel MOS field-effect transistor is configured to have a gate to which the switching voltage is supplied.

4. The bootstrap circuit according to claim 3, wherein
the P-channel MOS field-effect transistor is configured to have a drain to which the first control signal is supplied.

5. The bootstrap circuit according to claim 3, wherein
the level shifter includes a resistor provided between the gate and the drain of the P-channel MOS field-effect transistor.

6. The bootstrap circuit according to claim 3, wherein
the first switching element is a switching element configured to perform switching based on a second control signal,
the level shifter includes a second switch provided between the gate and the drain of the P-channel MOS field-effect transistor, and
the second switch is configured to perform switching based on the second control signal.

7. The bootstrap circuit according to claim 1, wherein
the first switching element and the second switching element are Si devices, and
the first control signal is an input signal of a driver configured to drive the second switching element.

8. The bootstrap circuit according to claim 1, wherein
the first switching element and the second switching element are GAN devices or SiC devices, and
the first control signal is an output signal of a driver configured to drive the second switching element.

9. The bootstrap circuit according to claim 1, wherein
the first switch is in an off state when the switching voltage has a value larger than a predetermined value.

10. A power supply device, comprising:
the bootstrap circuit according to claim 1;
the first switching element; and
the second switching element.

11. A vehicle comprising the power supply device according to claim 10.
